(19) United States
(12) Patent Application Publication
(10) Pub. No.: US 2026/0350549 A1
(43) Pub. Date: Nov. 5, 2026

(54) ENTERPRISE FRAMEWORK TO DETERMINE AND PREDICT THE EXTRA DISPATCH

(71) Applicant: Dell Products L.P., Round Rock, TX (US)

(72) Inventors: Parminder Singh Sethi, Punjab (IN); Lakshmi Saroja Nalam, Bangalore (IN); Praveen Kumar, Noida (IN)

(73) Assignee: Dell Products L.P., Round Rock, TX (US)

(21) Appl. No.: 19/194,411

(22) Filed: Apr. 30, 2025

(51) Int. Cl. G06Q 10/20; G06N 3/0442; G06Q 10/04

(52) U.S. Cl. CPC G06Q 10/20; G06N 3/0442; G06Q 10/04

(57) ABSTRACT

Methods, system, and non-transitory processor-readable storage medium for a dispatch analysis system are provided herein. An example method includes training, by a dispatch analysis system, a K-means clustering model using correlated data associated with dispatch activity to form clusters. The dispatch analysis system analyzes the formed clusters using silhouette analysis to determine optimal cluster separation, implements a Long Short-Term Memory (LSTM) neural network to generate predictive alerts to prevent needless dispatches based on the cluster analysis.

### FIELD

The field relates generally to preventing an extra, or unnecessary dispatch of hardware to a customer site, within information processing systems.

### BACKGROUND

Companies have automated dispatch processes that dispatch replacement parts when a customer reports a problem, or a device triggers an alert.

### SUMMARY

Illustrative embodiments provide techniques for implementing a dispatch analysis system in a storage system. For example, illustrative embodiments comprise a dispatch analysis system training a K-means clustering model using correlated data associated with dispatch activity to form clusters. The dispatch analysis system analyzes the formed clusters using silhouette analysis to determine optimal cluster separation. The dispatch analysis system implements a Long Short-Term Memory (LSTM) neural network to generate predictive alerts to prevent needless dispatches based on the cluster analysis. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 illustrates an information processing system including a dispatch analysis system, in an illustrative embodiment.

FIG. 2 illustrates a flow diagram of a process for a dispatch analysis system, in an illustrative embodiment.

FIG. 3 illustrates the dispatch analysis system workflow, in an illustrative embodiment.

FIG. 4 illustrates the clusters formed by K-Means, in an illustrative embodiment.

FIG. 5 illustrates the dispatch analysis process, in an example embodiment.

FIGS. 6 and 7 show examples of processing platforms that may be utilized to implement at least a portion of a dispatch analysis system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a dispatch analysis system, which technique may be used to avoid an unnecessary dispatch of hardware to a customer. The dispatch analysis system trains a K-means clustering model using correlated data associated with dispatch activity to form clusters. The dispatch analysis system analyzes the formed clusters using silhouette analysis to determine optimal cluster separation. The dispatch analysis system implements a Long Short-Term Memory (LSTM) neural network to generate predictive alerts to prevent needless dispatches based on the cluster analysis.

When customers purchase a part and/or product, the customer can also purchase a warranty for the purchased item. If the purchased item faces an issue, this can result in a dispatch of a new items, considering the following reasons, if the product is in warranty, if there is a Service Level Agreement (SLA) in effect, if the customer is considered to be a premium customer, if a repair is not possible, if a fix is not available at the time of the failure, if there is a manufacturing defect, etc.

Conventional technologies result in extra, unnecessary dispatches sent to customers, resulting in a revenue loss for the company. Conventional technologies lead to maintenance downtime at the customer site, while the customer waits for the arrival and installation of the replacement part, when there may be a different solution available for the customer's problem. Conventional technologies fail to provide corrective actions for the extra unnecessary dispatches. Conventional technologies determine an extra dispatch rate by calculating an average dispatch rate and comparing that to a current dispatch rate, but do not determine whether the average dispatch rate is indicative of an actual required dispatch rate.

By contrast, in at least some implementations in accordance with the current technique as described herein, an improvement in eliminating unnecessary dispatches of hardware to customers is achieved by a dispatch analysis system that trains a K-means clustering model using correlated data associated with dispatch activity to form clusters. The dispatch analysis system analyzes the formed clusters using silhouette analysis to determine optimal cluster separation. The dispatch analysis system implements a Long Short-Term Memory (LSTM) neural network to generate predictive alerts to prevent needless dispatches based on the cluster analysis.

Thus, a goal of the current technique is to analyze the historical data of dispatch (manual dispatch, self-dispatch and auto dispatch capabilities) and co-relate the historical data with the predictive alert/issue that happened in customer environments to identify if any extra/unnecessary dispatches have occurred. Another goal is to reduce if not eliminate the extra dispatches and the associated cumulative cost. Another goal is to determine an accurate dispatch rate based on the root cause of the device issue that triggered the alert. Yet another goal is to assist customers in resolving issues as part of the auto/self/manual dispatch process by using AI algorithms with historical telemetry data, along with support ticket information and knowledge based articles.

In at least some implementations in accordance with the current technique described herein, the use of a dispatch analysis system can provide one or more of the following advantages: providing corrective actions that address the customer's issue without incurring an unnecessary dispatch, providing an accurate, required dispatch rate, reducing if not eliminating the extra dispatches and the associated cumulative cost.

In contrast to conventional technologies, in at least some implementations in accordance with the current technique as described herein, an improvement in identifying when a technical solution can be provided that avoids an unnecessary dispatch of hardware to a customer is achieved by a dispatch analysis system that trains a K-means clustering model using correlated data associated with dispatch activity to form clusters. The dispatch analysis system analyzes the formed clusters using silhouette analysis to determine optimal cluster separation. The dispatch analysis system implements a Long Short-Term Memory (LSTM) neural network to generate predictive alerts to prevent needless dispatches based on the cluster analysis.

In an example embodiment of the current technique, a device management system receives a service request to dispatch a component to a customer.

In an example embodiment of the current technique, a dispatch analysis system generates the predictive alerts prior to processing the service request to determine whether a solution exists that avoids triggering the dispatch to the customer.

In an example embodiment of the current technique, the dispatch analysis system updates the LSTM neural network when the solution exists that avoids triggering the dispatch to the customer.

In an example embodiment of the current technique, the dispatch analysis system provides the solution, comprising corrective and fix actions, to technical support.

In an example embodiment of the current technique, the dispatch analysis system prevents a needless dispatch of parts during auto dispatch, self-dispatch, or manual dispatch processes by generating proactive alerts based on the LSTM predictions.

In an example embodiment of the current technique, the dispatch analysis system gathers device logs from enterprise devices at periodic intervals and upon alert triggers, where the device logs comprise system event logs, technical support reports, and lifecycle logs and gathers support ticket information comprising fix information, dispatch status, and component data.

In an example embodiment of the current technique, the dispatch analysis system collects data to determine device state, state transitions, duration of transitions, device configuration, component configuration, and workload of the device.

In an example embodiment of the current technique, the dispatch analysis system collates the gathered device logs and support ticket information to generate the correlated data.

In an example embodiment of the current technique, the dispatch analysis system maps features from the device logs to features from the support ticket information using alert trigger correlation.

In an example embodiment of the current technique, the dispatch analysis system collects problem symptoms, component information, and ticket counts for components over a specified time period.

In an example embodiment of the current technique, the dispatch analysis system forms the clusters with telemetry data and support ticket information.

In an example embodiment of the current technique, the dispatch analysis system calculates silhouette scores to assess cluster separation quality.

In an example embodiment of the current technique, the formed clusters are based on device model, age, workload, customer priority, component configuration, device state, duration of device state, and criticality of current state.

In an example embodiment of the current technique, the dispatch analysis system identifies needless dispatches within each cluster.

In an example embodiment of the current technique, the dispatch analysis system verifies if any data point lacks dispatch and tags points with dispatch as needless dispatch, verifies if all data points have dispatch and tags as not-needless dispatch, and verifies if no data points have dispatch and tags as not-needless dispatch.

In an example embodiment of the current technique, the dispatch analysis system trains separate LSTM models for each cluster to enable more tailored predictions.

In an example embodiment of the current technique, the dispatch analysis system creates additional features based on cluster assignments.

In an example embodiment of the current technique, the predictive alerts are generated before dispatch occurs.

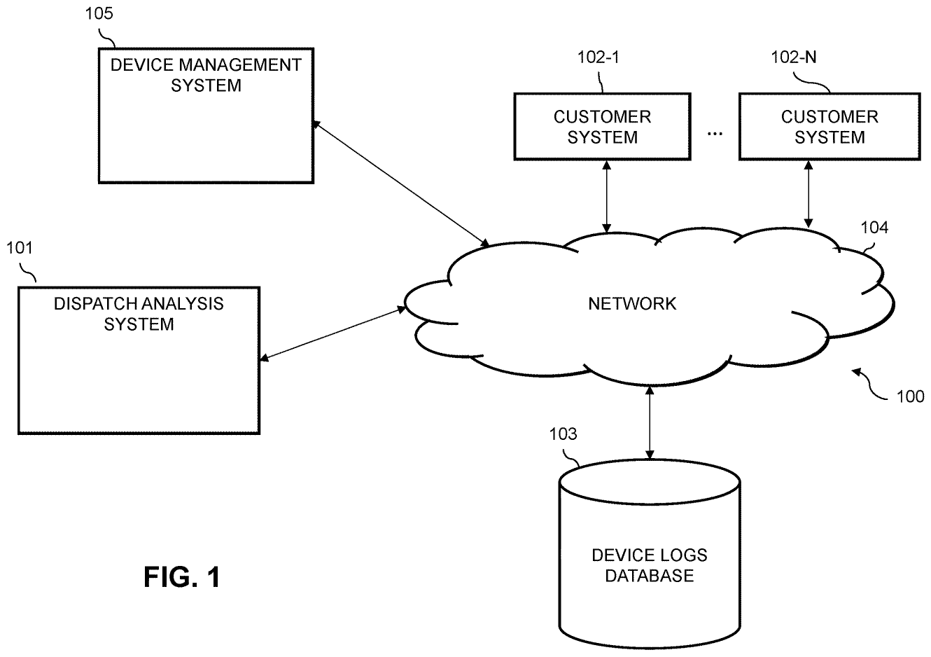

FIG. 1 shows a computer network (also referred to herein as an information processing system) 100 configured in accordance with an illustrative embodiment. The computer network 100 comprises a dispatch analysis system 101, a device management system 105, device logs database 103, and customer systems 102-N. The dispatch analysis system 101, device management system 105, device logs database 103, and customer systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The dispatch analysis system 101 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the dispatch analysis system 101, device management system 105, device logs database 103, and customer systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The dispatch analysis system 101, device management system 105, device logs database 103, and customer systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the dispatch analysis system 101 are one or more input-output devices, which illustratively comprise keyboards, displays or other types of input-output devices in any combination. Such input-output devices can be used, for example, to support one or more user interfaces to the dispatch analysis system 101, as well as to support communication between the dispatch analysis system 101 and other related systems and devices not explicitly shown. For example, a dashboard may be provided for a user to view results produced by the dispatch analysis system 101. One or more input-output devices may also be associated with any of the dispatch analysis system 101, device management system 105, device logs database 103, and customer systems 102-N.

Additionally, the dispatch analysis system 101 in the FIG. 1 embodiment is assumed to be implemented using at least one processing device. Each such processing device generally comprises at least one processor and an associated memory, and implements one or more functional modules for controlling certain features of the dispatch analysis system 101.

More particularly, the dispatch analysis system 101 in this embodiment can comprise a processor coupled to a memory and a network interface. The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the dispatch analysis system 101 to communicate over the network 104 with the dispatch analysis system 101, device management system 105, device logs database 103, and customer systems 102-N and illustratively comprises one or more conventional transceivers.

A dispatch analysis system 101 may be implemented at least in part in the form of software that is stored in memory and executed by a processor, and may reside in any processing device. The dispatch analysis system 101 may be a standalone plugin that may be included within a processing device.

It is to be understood that the particular set of elements shown in FIG. 1 for dispatch analysis system 101 involving the device management system 105, device logs database 103, and customer systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the dispatch analysis system 101 can be on and/or part of the same processing platform.

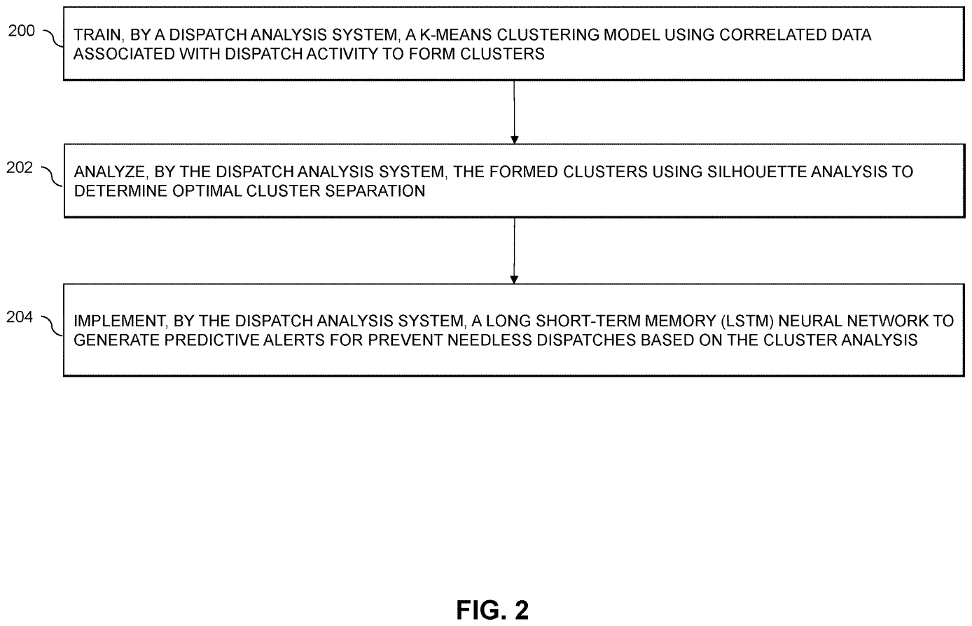

An exemplary process of dispatch analysis system 101 in computer network 100 will be described in more detail with reference to, for example, the flow diagram of FIG. 2.

FIG. 2 is a flow diagram of a process for execution of the dispatch analysis system 101 in an illustrative embodiment. It is to be understood that this particular process is only an example, and additional or alternative processes can be carried out in other embodiments.

In an example embodiment, the device management system 105 receives a service request to dispatch a component to a customer. The dispatch of parts/hardware refers to the process of sending replacement components or parts to customers or service centers for repairs or upgrades. This dispatch process is typically part of a company's support and warranty services, where the company ensures that the company's customers receive the necessary parts to fix their devices/hardware efficiently. In an example embodiment, a customer initiates a service request through a company's support portal, such as device management system 105, where the customer is able to track the status of their dispatch. There may be different types of dispatch, such as parts-only display, or parts and label, depending on the customer's service agreement with the company. In other words, a customer may receive just the replacement part(s) needed for self-repair or have a technician associated with the company come to the customer site to perform the repair. In addition, the customer may check the status of their dispatch using the service request number or a dispatch number, making it easier for the customer to anticipate when to expect the part(s) the customer requested.

At 200, the dispatch analysis system 101 trains a K-means clustering model using correlated data associated with dispatch activity to form clusters. In an example embodiment, the dispatch analysis system 101 gathers device logs from enterprise devices at periodic intervals and upon alert triggers, where the device logs comprise system event logs, technical support reports, support assist collection, and lifecycle logs. The dispatch analysis system 101 uses this collected information to determine the device states and their transition details, for example, state of the device, state transitions, duration of transitions, device configuration, component configuration, and workload of the device.

In an example embodiment, a service request or support ticket may be created by Tech Support, or as part of an auto creation process. In an example embodiment, the alerts may create support tickets based on rules defined in, for example, a policy file. In an example embodiment, the dispatch analysis system 101 gathers support ticket information comprising fix information, dispatch status, and component data. In an example embodiment, knowledge-based articles are referred to for resolution. The dispatch analysis system 101 may use the support ticket information and the knowledge-based articles to determine, for example, fix information, whether a dispatch occurred or not, whether a dispatch happened requiring labor or not (i.e., a technician sent to the customer site), components corresponding to each case number, problem, symptom, tickets count for each component during a time period, etc. The support ticket may result in a dispatch (i.e., sending a part/component to a customer), and/or even the service to fix the part at the customer's premises. In an example embodiment, the dispatch analysis system 101 collates the gathered device logs and support ticket information to generate the correlated data. In an example embodiment, the dispatch analysis system 101 maps features from the device logs to features from the support ticket information using alert trigger correlation. In an example embodiment, the dispatch analysis system 101 collects problem symptoms, component information, and ticket counts for components over a specified time period.

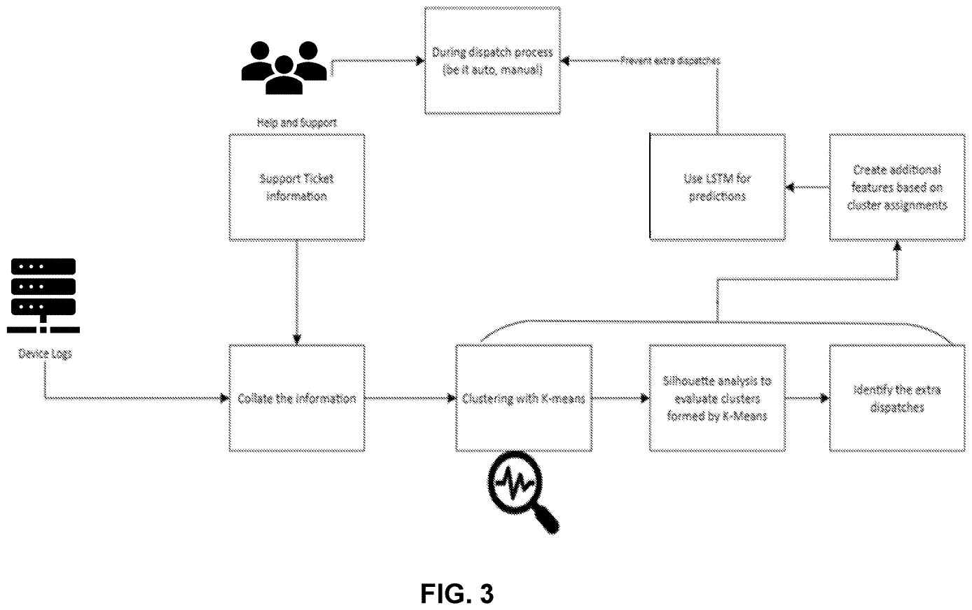

In an example embodiment, the dispatch analysis system 101 forms the clusters with telemetry data and support ticket information. In an example embodiment, when an alert is triggered (such as a product issue/failure), a support request/support ticket is generated. The support ticket also comprises telemetry information associated with the device that triggered the alert. In an example embodiment, the dispatch analysis system 101 collates the gathered device logs and support ticket information to generate the correlated data, and trains the K-means clustering model using correlated data associated with dispatch activity to form clusters. In an example embodiment, the clusters are formed using the sample data set of model, age, workload, priority of customer, component configuration, device state, duration of device in current state, criticality of current state, etc. In each cluster, the dispatch analysis system 101 determines if any extra/unnecessary dispatches occurred. FIG. 3 illustrates the dispatch analysis system workflow. In an example embodiment, the dispatch analysis system 101 uses the collated information (i.e., the device logs and support ticket information) to train the LSTM neural network using K-Means with Silhouette analysis. K-Means clustering is a method to group n number of observations into K clusters.

At 202, the dispatch analysis system 101 analyzes the formed clusters using silhouette analysis to determine optimal cluster separation. In an example embodiment, the dispatch analysis system 101 calculates silhouette scores to assess cluster separation quality. Silhouette analysis can help determine the optimal number of clusters (K) by calculating the average Silhouette score for different values of K. This measures how similar a point is to its own cluster (cohesion) compared to other clusters (separation). Silhouette values range from +1 (well-clustered) to −1 (misclassified). In an example embodiment, the dispatch analysis system 101 calculates the silhouette score for different k values, and chooses the k with the highest silhouette score.

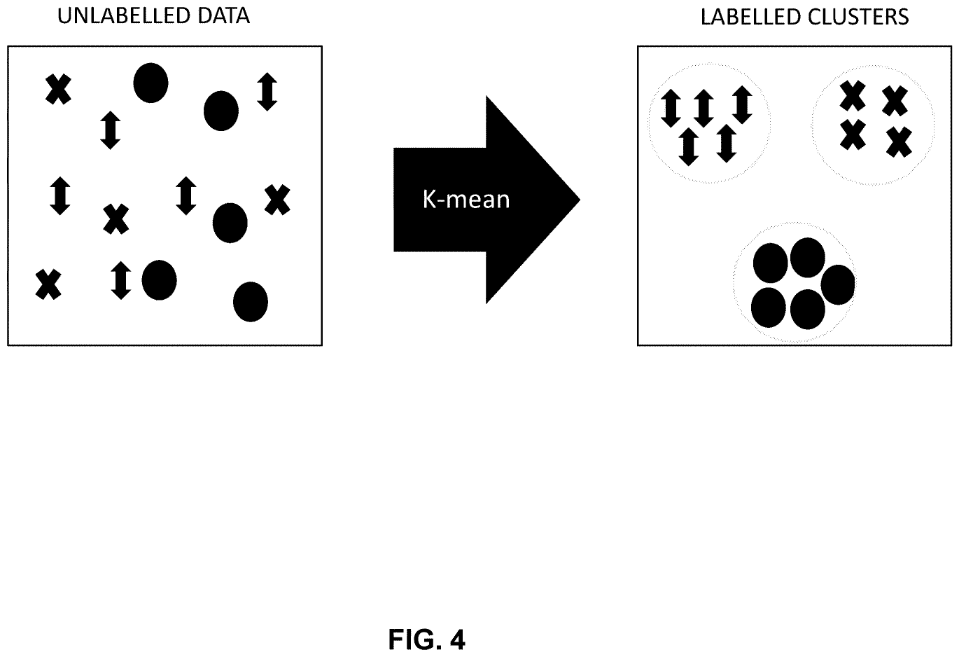

As noted above, the clusters are formed with the telemetry data and support ticket information. In an example embodiment, the dispatch analysis system 101 initializes k points in a random manner (referred to as means or cluster centroids). The dispatch analysis system 101 categorizes each data point to its closest mean and updates the mean's coordinates (which are the averages of the items categorized in the cluster at that point). The dispatch analysis system 101 repeats the process for a given number of iterations to reach the desired clusters. The Silhouette Analysis provides a way to assess how well-separated the clusters are. In an example embodiment, the dispatch analysis system 101 calculates the Silhouette score for each data point. For example, a cluster contains the model (M) with the current state S0, components C1 and C2, dispatch is required (or not). FIG. 4 illustrates the clusters formed by K-Means.

In an example embodiment, the formed clusters are based on device model, age, workload, customer priority, component configuration, device state, duration of device state, and criticality of current state.

In an example embodiment, the dispatch analysis system 101 identifies needless dispatches within each cluster. In an example embodiment, in each cluster, the dispatch analysis system 101 verifies if any data point lacks dispatch and tags points with dispatch as needless dispatch, verifies if all data points have dispatch and tags as not-needless dispatch, and verifies if no data points have dispatch and tags as not-needless dispatch.

At 204, the dispatch analysis system 101 implements a Long Short-Term Memory (LSTM) neural network to generate predictive alerts to prevent needless dispatches based on the cluster analysis. In an example embodiment, the dispatch analysis system 101 creates additional features based on cluster assignments. The insights gained from clustering significantly enhance feature engineering by allowing the creation of additional features based on the cluster assignments. This analysis improves the model interpretability, since it helps understand how different data segments behave, guiding the interpretation of LSTM neural network predictions. By incorporating cluster labels as features, the LSTM model learns from the behavior of similar data points. If clusters exhibit distinct behaviors, the dispatch analysis system 101 trains separate LSTM models for each cluster to enable more tailored predictions.

The dispatch analysis system 101 uses a structured approach to effectively leverages clustering and LSTM networks to analyze and predict outcomes from timeseries data. In an example embodiment, the dispatch analysis system 101 uses feature engineering to extract relevant features from raw timeseries data. The dispatch analysis system 101 uses time-series decomposition to break down the timeseries date to understand underlying patterns. The dispatch analysis system 101 uses windowing techniques to create segments of data using sliding windows for model training. The dispatch analysis system 101 uses encoding methods to use delta encoding for continuous data and one-hot encoding for categorical data. The dispatch analysis system 101 uses data structures to employ timeseries databases or data frames for efficient data manipulation. The dispatch analysis system 101 uses clustering with K-Means to group similar data points to identify patterns or anomalies. The dispatch analysis system 101 uses Silhouette Analysis to evaluate cluster quality by calculating silhouette scores for separation assessment. The dispatch analysis system 101 uses machine learning models with LSTM to implement LSTM networks for predictions, normalizing and training the data. The dispatch analysis system 101 analyzes results to visualize predictions against actual values and examine cluster correlations. The dispatch analysis system 101 fine-tunes the model, experimenting with hyperparameters and architectures to enhance model performance.

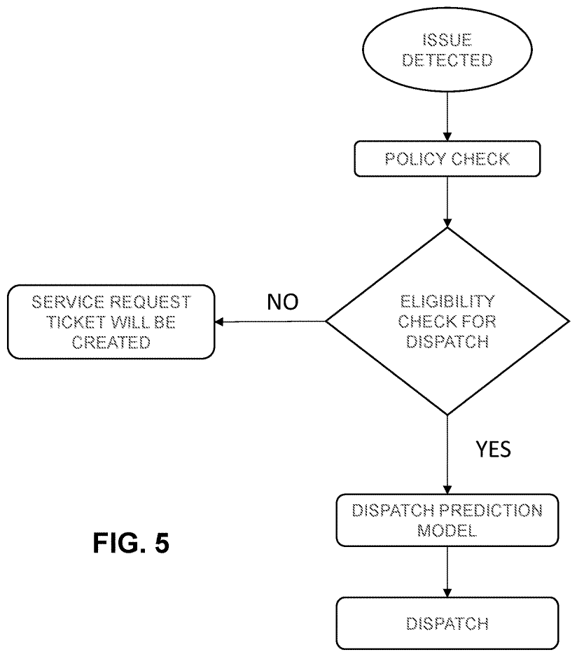

Dispatches are sent to customers as part of the auto dispatch process, self-dispatch process and/or manual dispatch by Tech Support as part of an incident. In conjunction with the LSTM neural network, the dispatch analysis system 101 generates predictive alerts for, for example, Tech Support, if any extra/unnecessary dispatch is about to occur for a customer. The dispatch analysis system 101 prevents a needless dispatch of parts during auto dispatch, self-dispatch, or manual dispatch processes by generating proactive alerts based on the LSTM predictions. In other words, the predictive alerts are generated before dispatch occurs. In an example embodiment, the dispatch analysis system 101 generates the predictive alerts prior to processing the service request to determine whether a solution exists that avoids triggering the dispatch to the customer. If the solution exists that avoids triggering the dispatch, the dispatch analysis system 101 provides the solution, comprising corrective and fix actions, to technical support. Additionally, the dispatch analysis system 101 updates the LSTM neural network when the solution exists that avoids triggering the dispatch to the customer. FIG. 5 illustrates the dispatch analysis process.

The above-described illustrative embodiments provide significant advantages relative to conventional approaches. For example, some embodiments are configured to avoid an unnecessary dispatch of hardware to a customer. These and other embodiments can effectively reduce if not eliminate the extra dispatches and the associated cumulative cost. Embodiments disclosed herein provide corrective actions that address the customer's issue without incurring an unnecessary dispatch. Embodiments disclosed herein provide an accurate, required dispatch rate. Embodiments disclosed herein assist customers in resolving issues as part of the auto/self/manual dispatch process.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

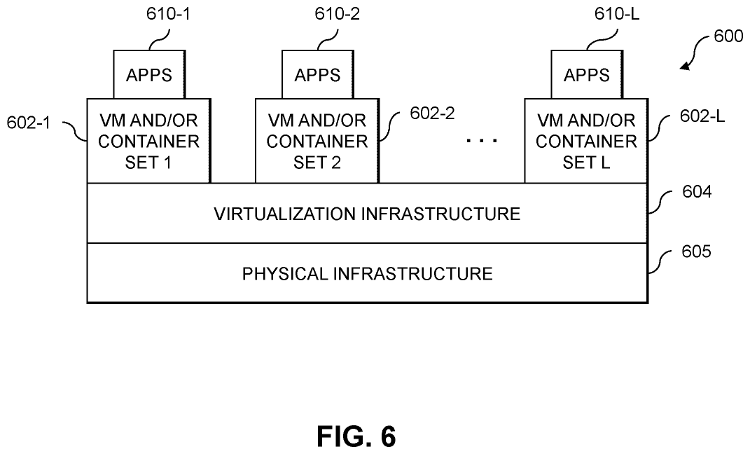

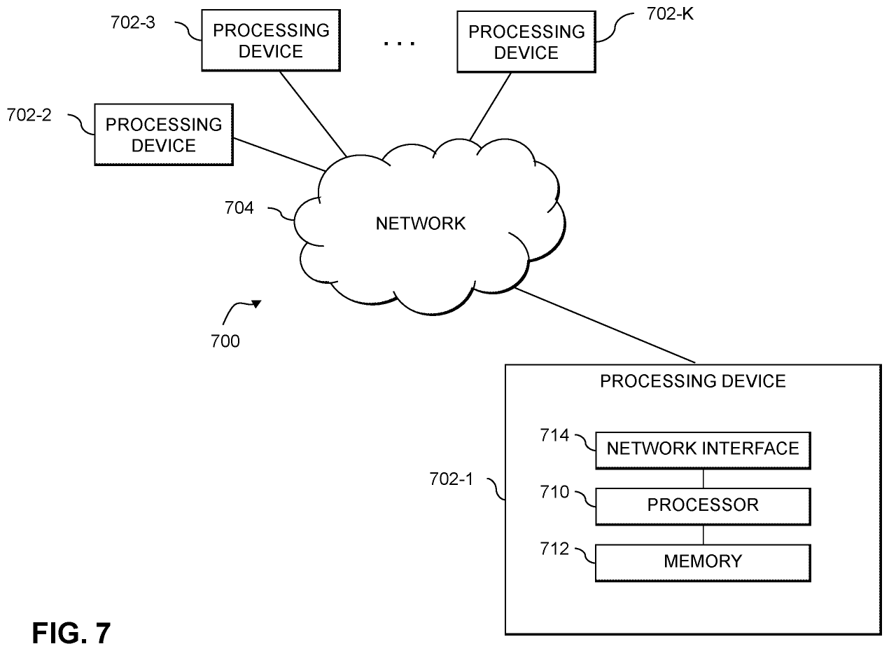

Illustrative embodiments of processing platforms will now be described in greater detail with reference to FIGS. 6 and 7. Although described in the context of the information processing system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines comprise one or more distributed processing platforms that include one or more storage systems. The VMs can implement at least portions of the dispatch analysis system 101 in illustrative embodiments.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such containers can implement at least portions of the dispatch analysis system 101 in illustrative embodiments.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of the information processing system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
training, by a dispatch analysis system, a K-means clustering model using correlated data associated with dispatch activity to form clusters, wherein the correlated data comprises device logs gathered from enterprise devices and support ticket information comprising dispatch status reflecting prior dispatches of physical replacement hardware components to customer sites under warranty or service-level agreements, and wherein the correlated data is generated by collating the gathered device logs and the support ticket information by mapping features from the device logs to features from the support ticket information using alert trigger correlation;
analyzing, by the dispatch analysis system, the formed clusters using silhouette analysis to determine optimal cluster separation, wherein analyzing the formed clusters comprises identifying needless dispatches within each cluster by: verifying if any data point within the cluster lacks dispatch and tagging data points within the cluster that have dispatch as needless dispatch; verifying if all data points within the cluster have dispatch and tagging the cluster as not-needless dispatch; and verifying if no data points within the cluster have dispatch and tagging the cluster as not-needless dispatch; and
implementing, by the dispatch analysis system, a Long Short-Term Memory (LSTM) neural network to generate predictive alerts to prevent needless dispatches based on the cluster analysis, wherein the predictive alerts are generated prior to processing a service request, received by a device management system from a customer, to dispatch a physical replacement hardware component to the customer's site, to determine whether a solution exists that avoids triggering the dispatch of the physical replacement hardware component to the customer, wherein the method is implemented by at least one processing device comprising a processor coupled to a memory.

2. (canceled)

3. The method of claim 1, further comprising:
updating the LSTM neural network when the solution exists that avoids triggering the dispatch to the customer.

4. The method of claim 1, further comprising:
providing the solution, comprising corrective and fix actions, to technical support.

5. The method of claim 1, further comprising:
preventing a needless dispatch of parts during auto dispatch, self-dispatch, or manual dispatch processes by generating proactive alerts based on the LSTM predictions.

6. The method of claim 1, further comprising:
gathering device logs from enterprise devices at periodic intervals and upon alert triggers, wherein the device logs comprise system event logs, technical support reports, and lifecycle logs; and
gathering support ticket information comprising fix information, dispatch status, and component data.

7. The method of claim 6, wherein gathering the device logs comprises:
collecting data to determine device state, state transitions, duration of transitions, device configuration, component configuration, and workload of the device.

8. (canceled)

9. (canceled)

10. The method of claim 6, wherein gathering the support ticket information comprises:
collecting problem symptoms, component information, and ticket counts for components over a specified time period.

11. (canceled)

12. The method of claim 1, wherein analyzing, by the dispatch analysis system, the formed clusters using silhouette analysis comprises:
calculating silhouette scores to assess cluster separation quality.

13. The method of claim 1, wherein the formed clusters are based on device model, age, workload, customer priority, component configuration, device state, duration of device state, and criticality of current state.

14. (canceled)

15. (canceled)

16. The method of claim 1, wherein implementing, by the dispatch analysis system, a Long Short-Term Memory (LSTM) neural network to generate predictive alerts comprises:
training separate LSTM models for each cluster to enable more tailored predictions.

17. The method of claim 1, wherein implementing, by the dispatch analysis system, a Long Short-Term Memory (LSTM) neural network to generate predictive alerts comprises:
creating additional features based on cluster assignments.

18. (canceled)

19. A system comprising:
at least one processing device comprising a processor coupled to a memory;
the at least one processing device being configured:
to train, by a dispatch analysis system, a K-means clustering model using correlated data associated with dispatch activity to form clusters, wherein the correlated data comprises device logs gathered from enterprise devices and support ticket information comprising dispatch status reflecting prior dispatches of physical replacement hardware components to customer sites under warranty or service-level agreements, and wherein the correlated data is generated by collating the gathered device logs and the support ticket information by mapping features from the device logs to features from the support ticket information using alert trigger correlation;
to analyze, by the dispatch analysis system, the formed clusters using silhouette analysis to determine optimal cluster separation, wherein analyzing the formed clusters comprises identifying needless dispatches within each cluster by: verifying if any data point within the cluster lacks dispatch and tagging data points within the cluster that have dispatch as needless dispatch; verifying if all data points within the cluster have dispatch and tagging the cluster as not-needless dispatch; and verifying if no data points within the cluster have dispatch and tagging the cluster as not-needless dispatch; and
to implement, by the dispatch analysis system, a Long Short-Term Memory (LSTM) neural network to generate predictive alerts to prevent needless dispatches based on the cluster analysis, wherein the predictive alerts are generated prior to processing a service request, received by a device management system from a customer, to dispatch a physical replacement hardware component to the customer's site, to determine whether a solution exists that avoids triggering the dispatch of the physical replacement hardware component to the customer.

20. A computer program product comprising a non-transitory processor-readable storage medium having stored therein program code of one or more software programs, wherein the program code when executed by at least one processing device causes the at least one processing device:
to train, by a dispatch analysis system, a K-means clustering model using correlated data associated with dispatch activity to form clusters, wherein the correlated data comprises device logs gathered from enterprise devices and support ticket information comprising dispatch status reflecting prior dispatches of physical replacement hardware components to customer sites under warranty or service-level agreements, and wherein the correlated data is generated by collating the gathered device logs and the support ticket information by mapping features from the device logs to features from the support ticket information using alert trigger correlation;
to analyze, by the dispatch analysis system, the formed clusters using silhouette analysis to determine optimal cluster separation, wherein analyzing the formed clusters comprises identifying needless dispatches within each cluster by: verifying if any data point within the cluster lacks dispatch and tagging data points within the cluster that have dispatch as needless dispatch; verifying if all data points within the cluster have dispatch and tagging the cluster as not-needless dispatch; and verifying if no data points within the cluster have dispatch and tagging the cluster as not-needless dispatch; and
to implement, by the dispatch analysis system, a Long Short-Term Memory (LSTM) neural network to generate predictive alerts to prevent needless dispatches based on the cluster analysis, wherein the predictive alerts are generated prior to processing a service request, received by a device management system from a customer, to dispatch a physical replacement hardware component to the customer's site, to determine whether a solution exists that avoids triggering the dispatch of the physical replacement hardware component to the customer.
